(19) United States
(12) Patent Application Publication
(10) Pub. No.: US 2008/0184377 A1
(43) Pub. Date: Jul. 31, 2008

(54) APPARATUS FOR RESTRICTING NUMBER OF TIMES OF USE OF IMAGE AND METHOD FOR RESTRICTING NUMBER OF TIMES OF USE OF IMAGE

(75) Inventor: Hiroyuki Kato, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,173

(22) Filed: Jan. 29, 2007

(51) Int. Cl. G06F 7/04

(52) U.S. Cl. 726/30

(57) ABSTRACT

In order to provide a number-of-times-of-image-use restricting apparatus that can prevent cost for communication with a server connected to a network from being incurred and apply restriction on use to image data, a number-of-times-of-image-use restricting apparatus includes a metadata storing unit that embed, according to use of image data, the number of times of use of the image data in the image data as metadata, a metadata reading unit that reads the number of times of use by reading the metadata embedded in the image data, and a number-of-times-of-use managing unit that manages the number of times of use of the image data on the basis of the number of times of use read by the metadata reading unit and a predetermined upper limit number of times of use.

### BACKGROUND OF THE INVENTION

1. Field of the Invention

The present invention relates to a number-of-times-of-image-use restricting apparatus and the like for restricting, for example, when image data or the like as an object of billing is subjected to print processing or the like by an image forming apparatus, the number of times of use of the image data. More particularly, the present invention relates to a number-of-times-of-image-use restricting apparatus and a number-of-times-of-image-use restricting method with which an image forming apparatus restricts the number of times of use of image data using the number of times of use embedded in the image data as metadata.

2. Description of the Related Art

Conventionally, when a user prints image data as an object of billing using an image forming apparatus such as an MFP (Multi Function Peripherals) installed in a shop or the like, the number of times of use of image data as well as the number of prints are restricted. In other words, since not only printing cost due to the number of prints but also a royalty for image data is an object of billing, the number of times of use of the image data is restricted to authenticate a print requester and meet a legal output request (print request).

For example, in a patent document 1 (JP-A-2003-58349), a technique for storing processing object information including output restriction information in a storage device in advance, comparing a possible number of times of use included in the processing object information with the number of times of use to the present, and, when the processing object information exceeds the possible number of times of use, inhibiting output (printing) of the processing object information requested to be outputted (requested to be printed).

In a digital contents management system performed in the digital music delivery industry, there is a number-of-copies managing system that allows digital copy to be performed up to once.

However, in the technique of the patent document 1, essential information such as an effective number of times of execution and the like as billing is centrally stored in a central server (a ticket control server). In this case, since all pieces of information are grasped by the ticket control server, it is always necessary to make inquiries to the ticket control server when determination on execution possibility of printing is performed. Therefore, in restricting use of the processing object information (e.g., image data), it is always necessary to access the ticket control server. As a result, excess communication cost is incurred. In the digital contents management system, since use of a copy is restricted to only once, this system is extremely inconvenience when a copy mistake occurs because there is no margin in restriction on use.

### SUMMARY OF THE INVENTION

The invention has been devised to solve the problems described above and it is an object of the invention to provide a number-of-times-of-image-use restricting apparatus and a number-of-times-of-image-use restricting method that can prevent cost for communication with a server connected to a network from being incurred and apply restriction on use to image data.

In order to solve the problems, a number-of-times-of-image-use restricting apparatus according to the invention includes a metadata storing unit that embed, according to use of image data, the number of times of use of the image data in the image data as metadata, a metadata reading unit that reads the number of times of use by reading the metadata embedded in the image data, and a number-of-times-of-use managing unit that manages the number of times of use of the image data on the basis of the number of times of use read by the metadata reading unit and a predetermined upper limit number of times of use.

A number-of-times-of-image-use restricting apparatus according to the invention includes metadata storing means for embedding, according to use of image data, the number of times of use of the image data in the image data as metadata, metadata reading means for reading the number of times of use by reading the metadata embedded in the image data, and number-of-times-of-use managing means for managing the number of times of use of the image data on the basis of the number of times of use read by the metadata reading unit and a predetermined upper limit number of times of use.

The invention provides a number-of-times-of-image-use restricting method for managing the number of times of use of image data using a computer, the method including embedding, according to use of the image data, the number of times of use of the image data as metadata, reading the metadata embedded to acquire the number of times of use when the image data is used the next time, and comparing the number of times acquired with a predetermined upper limit number of times of use to manage the number of times of use of the image data.

### DESCRIPTION OF THE DRAWINGS

FIG. 1 is a conceptual diagram showing an overall structure of a number-of-times-of-image-use restricting apparatus applied to an embodiment of the invention;

FIG. 2 is a block diagram showing an internal structure of an MFP shown in FIG. 1;

FIG. 3 is a block diagram showing an internal structure of a PC shown in FIG. 1;

FIG. 4 is a block diagram showing an internal structure of an image file of the MFP shown in FIG. 1;

FIG. 5 is a diagram showing an actual example of metadata in the case of Adobe, PDF, XMP;

FIG. 6 is a diagram showing an example of metadata 1 in an image-use history section shown in FIG. 4;

FIG. 7 is a diagram showing an example of metadata 2 in a use-upper-limit information section shown in FIG. 4;

FIG. 8 is a diagram showing an example of a template stored in storages in FIGS. 2 and 3;

FIG. 9 is a flowchart showing a flow of processing at the time of metadata registration in the number-of-times-of-image-use restricting apparatus according to the embodiment;

FIG. 10 is a flowchart showing a flow of processing of determination of an upper limit of use of an image in the number-of-times-of-image-use restricting apparatus according to the embodiment;

FIG. 11 is a flowchart showing a flow of processing for copying an image file with metadata in the number-of-times-of-image-use restricting apparatus according to the embodiment; and

FIG. 12 is a conceptual diagram showing a control panel of the MFP.

### DESCRIPTION OF THE EMBODIMENTS

A number-of-times-of-image-use restricting apparatus according to an embodiment of the invention makes it possible to restrict use of an image while making communication to a server unnecessary by embedding metadata concerning restriction on use of an image (equivalent to the number of times of use and an upper limit number of times of use according to the invention) for each image and applying restriction on processing (e.g., restriction on use of functions of an MFP) to an image using the metadata embedded.

In an explanation of the embodiment, the upper limit number of times of use as well as the number of times of use is embedded in image data as metadata. However, it is possible to more efficiently perform processing by providing this upper limit number of times of use on the MFP side when, for example, an upper limit number of times of use of an image is held uniformly for all images. A technique for embedding metadata in image data used in the embodiment is a technique known in, for example, XMP of Adobe PDF and EXIF of JPEG. Thus, an explanation of the technique is omitted (see, for example, http://www.adobe.com/products/xmp/main.html).

As functions of the MFP, there are various functions such as printing, electronic mail transmission, file transmission, and FAX transmission. It is possible to apply more careful restriction on use of functions of the MFP to a user by applying restriction on execution in each processing unit in a unit of image (image data) in these functions. Moreover, it is possible to apply restriction on use of the functions of the MFP in a unit of page (image data) rather than in a unit of document by embedding metadata concerning restriction on use in a unit of image.

An embodiment of a number-of-times-of-image-use restricting apparatus according to the invention will be hereinafter explained in detail with reference to the drawings.

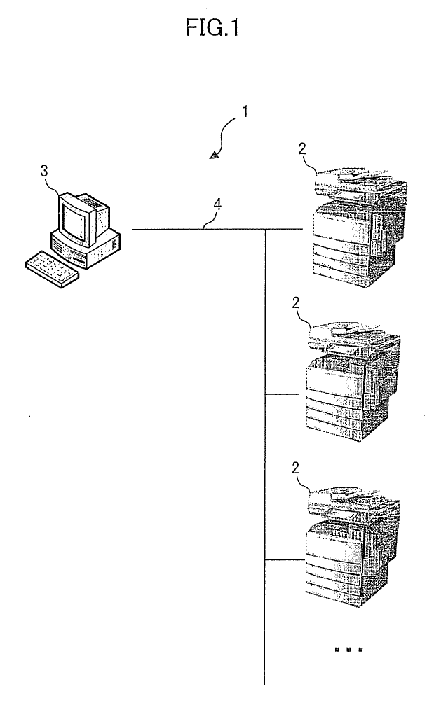

FIG. 1 is a conceptual diagram showing an overall structure of the number-of-times-of-image-use restricting apparatus applied to the embodiment of the invention. As shown in FIG. 1, a number-of-times-of-image-use restricting apparatus 1 has a structure in which plural MFPs 2 and a PC 3 are connected on a network 4 such as a LAN. The MFP 2 is a terminal apparatus in which functions of a copier, a facsimile, a printer, a scanner, and the like are integrated into one apparatus and served for efficient office work and is called a multifunction peripheral or the like. Therefore, the MFP 2 has, as plural functions, functions such as copying, network printing, network scanning, and FAX transmission and reception. There are also a function of storing scan images in the inside of the MFP 2 and making use of the scan images and the like. Moreover, there is also a function of applying printing, file transmission, electronic mail transmission, FAX transmission, and the like to images stored in the inside of the MFP 2 and outputting the images to the outside of the MFP 2.

The PC 3 is a personal computer and is an external terminal. Applications used in offices such as “Office” of Microsoft Corporation® are installed in the PC 3. Moreover, printer drivers for performing printing are installed in the PC 3 and the MFP 2.

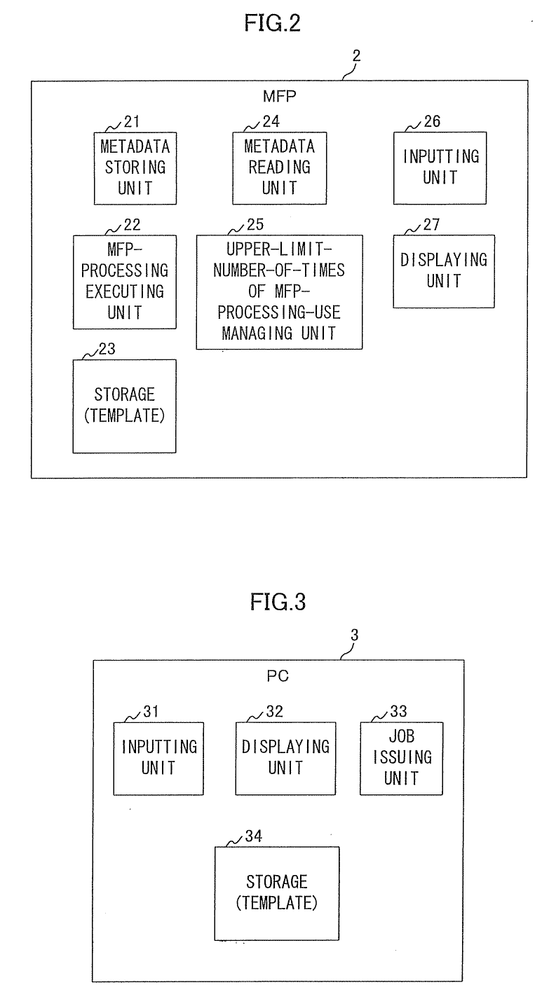

FIG. 2 is a block diagram showing an internal structure of the MFP 2 shown in FIG. 1. The MFP 2 includes a metadata storing unit 21, an MFP-processing executing unit 22, a storage 23 having stored therein a template for setting use restriction information, a metadata reading unit 24, an upper-limit-number-of-times of MFP-processing-use managing unit 25, an inputting unit 26, and a displaying unit 27.

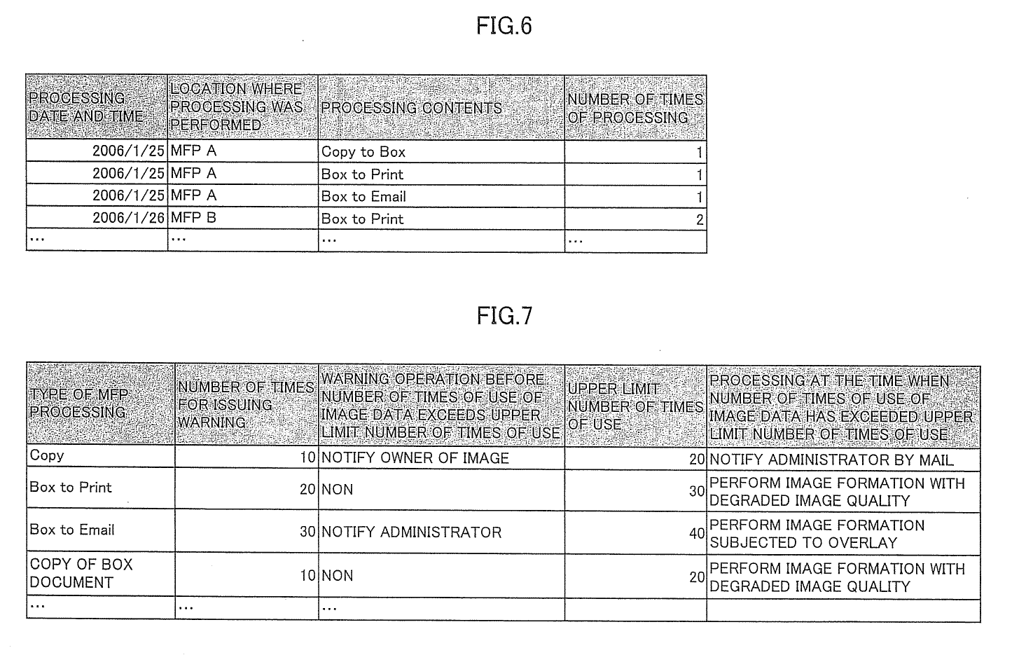

The metadata storing unit 21 embeds information on a history of use of an image (the number of times of use) and an upper limit number of times of use of the image (details are described later using FIGS. 6 and 7) in image data as metadata.

The MFP-processing executing unit (equivalent to an image-formation-processing executing unit (means) of the invention) 22 is a unit that executes various functions on the MFP 2. The MFP-processing executing unit 22 performs, for example, copying, network printing, network scanning, and FAX transmission and reception.

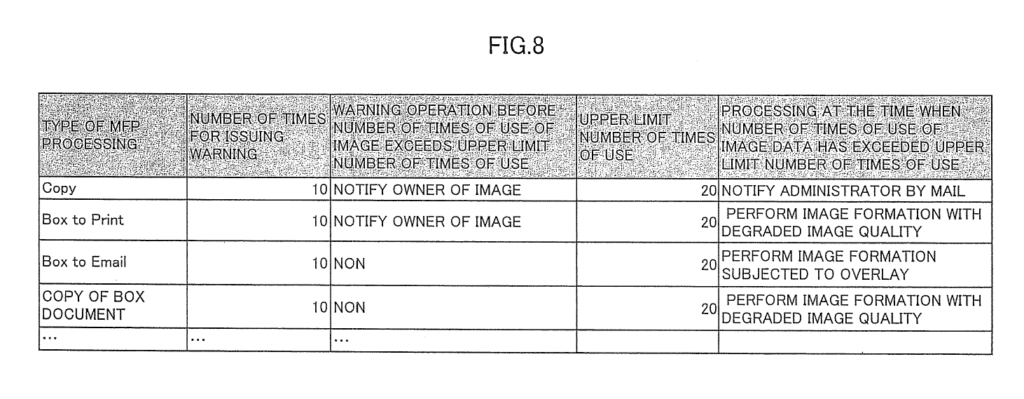

The template stored in the storage 23 is used for setting information on restriction on use of image data used in MFP processing (see FIG. 8).

The metadata reading unit (equivalent to metadata reading means of the invention) 24 reads metadata embedded in an image.

The upper-limit-number-of-times of MFP-processing-use managing unit (equivalent to a number-of-times-of-use managing unit or number-of-times-of-use managing means of the invention) 25 is a unit that analyzes the metadata read by the metadata reading unit 24, determines whether the number of times of use of the image is about to reach an upper limit number of times of use of the MFP processing or has exceeded the upper limit number of times of use of the MFP processing, and requests the MFP-processing executing unit 22 to execute processing corresponding to a result of the determination.

The inputting unit 26 executes input processing among user interfaces of the MFP 2. The displaying unit 27 is a unit that executes display processing among the user interfaces of the MFP 2.

FIG. 3 is a block diagram showing an internal structure of the PC 3 shown in FIG. 1. The inside of the PC 3 includes an inputting unit 31, a displaying unit 32, a job issuing unit 33, and a storage 34.

The inputting unit 31 executes input processing among the user interfaces of the PC 3. The displaying unit 32 executes display processing among the user interfaces of the PC 3. The job issuing unit 33 requests the MFP 2 to issue a job in the same manner as, for example, a printer driver. The storage 34 has recorded therein information on restriction on use of image data used in the MFP processing in the same manner as the storage 23. A user can also set information on restriction on use of image data according to the template stored in the storage 34 of the PC 3.

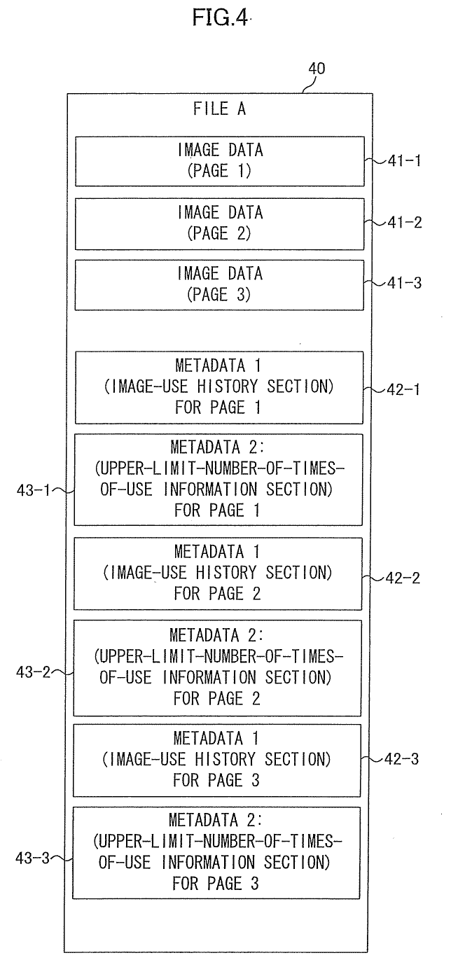

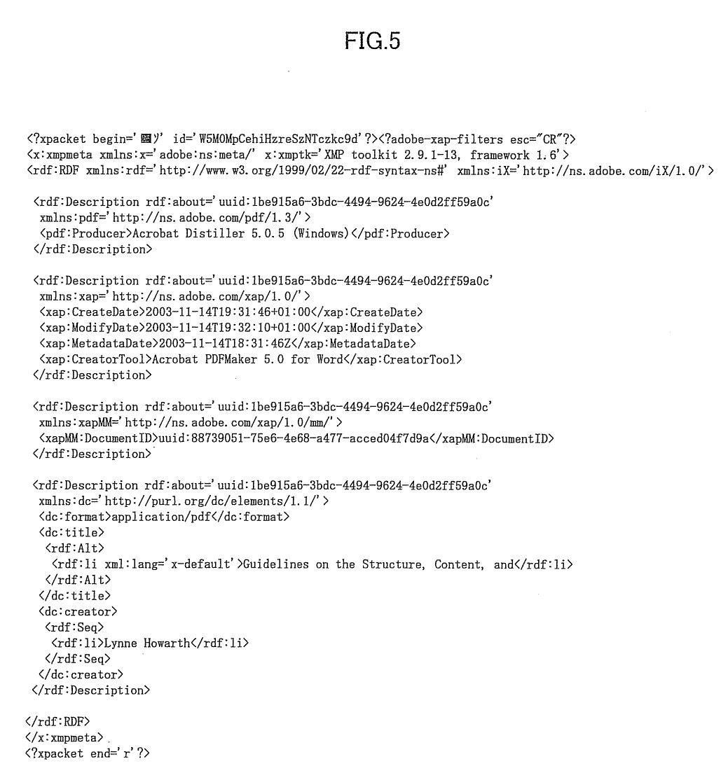

FIG. 4 is a block diagram showing a structure of image file of the MFP 2 shown in FIG. 1. Metadata, an example of which is shown in FIG. 5, is embedded in this image data. The metadata in FIG. 5 indicates an actual example in the case of Adobe PDF, XMP. As a format of metadata embedded in PDF of Adobe, XMP is defined as specifications. The metadata is described in terms of a description language.

A file 40 of the image data shown in FIG. 4 includes, as image data, image data 41-1 forming a page 1, image data 41-2 forming a page 2, and image data 41-3 forming a page 3. The file 40 includes, as areas in which metadata 1 is embedded, an image-use history section 42-1 in which the metadata 1 for the page 1 is embedded, an image-use history section 42-2 in which the metadata 1 for the page 2 is embedded, and an image-use history section 42-3 in which the metadata 1 for the page 3 is embedded.

Moreover, the file 40 includes, as areas in which metadata 2 is embedded, an upper-limit-number-of-times-of-use information section 43-1 in which the metadata 2 for the page 1 is embedded, an upper-limit-number-of-times-of-use information section 43-2 in which the metadata 2 for the page 2 is embedded, and an upper-limit-number-of-times-of-use information section 43-3 in which the metadata 2 for the page 3 is embedded.

An example of details of the image-use history sections 42-1, 42-2, and 42-3 in which the metadata 1 of the respective pages are embedded is shown in FIG. 6. An example of details of the upper-limit-number-of-times-of-use information sections 43-1, 43-2, and 43-3 of the metadata 2 is shown in FIG. 7.

The metadata 1 shown in FIG. 6 has information on each of a “processing date and time”, a “location where processing was performed”, “processing contents”, and a “processing number of times”. Every time processing is carried out in the inside of the MFP 2 (every time image data is used), these four items are added to the metadata 1 as one line.

The “processing date and time” indicates a date and time when processing by the MFP 2 was carried out. The “location where processing was performed” indicates a location where the processing by the MFP 2 was carried out (an installation location of the MFP 2 that performed the processing or a name of the MFP 2). The “processing contents” indicate contents of the processing by the MFP 2 (a function name: equivalent to a type of processing of the invention). The “processing number of times” indicates the number of times the processing was performed. For example, copying was carried out with the number of copies of 2, 2 is recorded in the space of the “processing number of times”. This “processing number of times” is equivalent to the number of times of use of image data of the invention.

The metadata 2 shown in FIG. 7 has information on each of a “type of MFP processing”, a “number of times for issuing a warning”, a “warning operation setting before the number of times of use of image data exceeds an upper limit number of times of use”, an “upper limit number of times of use”, and “processing at the time when the number of times of use of image data has exceeded an upper limit number of times of use”. As the metadata 2, these five items are described as one line for each of the functions in the inside of the MFP 2.

The “type of MFP processing” is a function name such as a printing function of an MFP. The “number of times for issuing a warning” is the number of times of use a warning operation is performed when the warning operation is performed before the number of times of use of image data exceeds an upper limit number of times of use. In the “warning operation before the number of times of use of image data exceeds an upper limit number of times of use”, contents of the warning operation are set. For example, an operation for notifying an owner of an image of a warning by electronic mail and an operation for notifying an administrator of the MFP of a warning by electronic mail are set.

The “upper limit number of times of use” is the number of times used for determining whether the number of times of use exceeds the upper limit. In the “processing at the time when the number of times of use of image data has exceeded an upper limit number of times of use”, the processing contents are set. For example, processing for notifying the administrator by electronic mail, processing for performing image formation with a degraded image quality (e.g., forming an image with resolution thereof degraded from 600 dpi to 100 dpi), and processing for performing image formation subjected to overlay (e.g., forming an image with characters such as “the number of times of use of image data has exceeded use limit” overwritten thereon) are set.

FIG. 8 is a diagram showing an example of the template stored in the storages 23 and 34 in FIGS. 2 and 3. This template becomes a template of the metadata 2 shown in FIG. 7 and is used when use restriction information is set for an image. The MFP 2 presents this information to the user. The user is capable of changing the number of times of use of the image, an operation setting, and the like according to the image on the basis of this information.

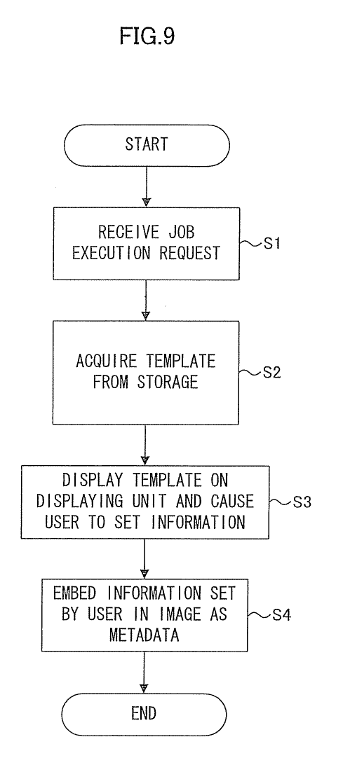

FIG. 9 is a flowchart showing a flow of processing at the time of metadata registration in the number-of-times-of-image-use restricting apparatus restricting apparatus according to this embodiment.

First, the MFP 2 accepts a request for execution of a job that uses new image data (step S1). As the job that uses image data, there are jobs for inputting an image to the MFP 2 from the outside and causing the MFP 2 process the image such as Copy & Box, Scan to File & Box, Scan to Box, Network Print & Box, received Fax & Box.

The MFP 2 acquires the template of the metadata 2 from the storage 23 (step S2), displays the template acquired, and causes the user to set the information shown in FIG. 8 (the information related to restriction on use) (step S3).

The MFP 2 embeds (adds) the information set by the user using the template in the image as metadata (step S4).

When network printing is performed from the client PC 3 using a printer driver, processing is carried out according to the same flow. In this case, the user performs metadata setting on, for example, a screen of a printer driver using the template obtained from the storage 34 of the PC 3.

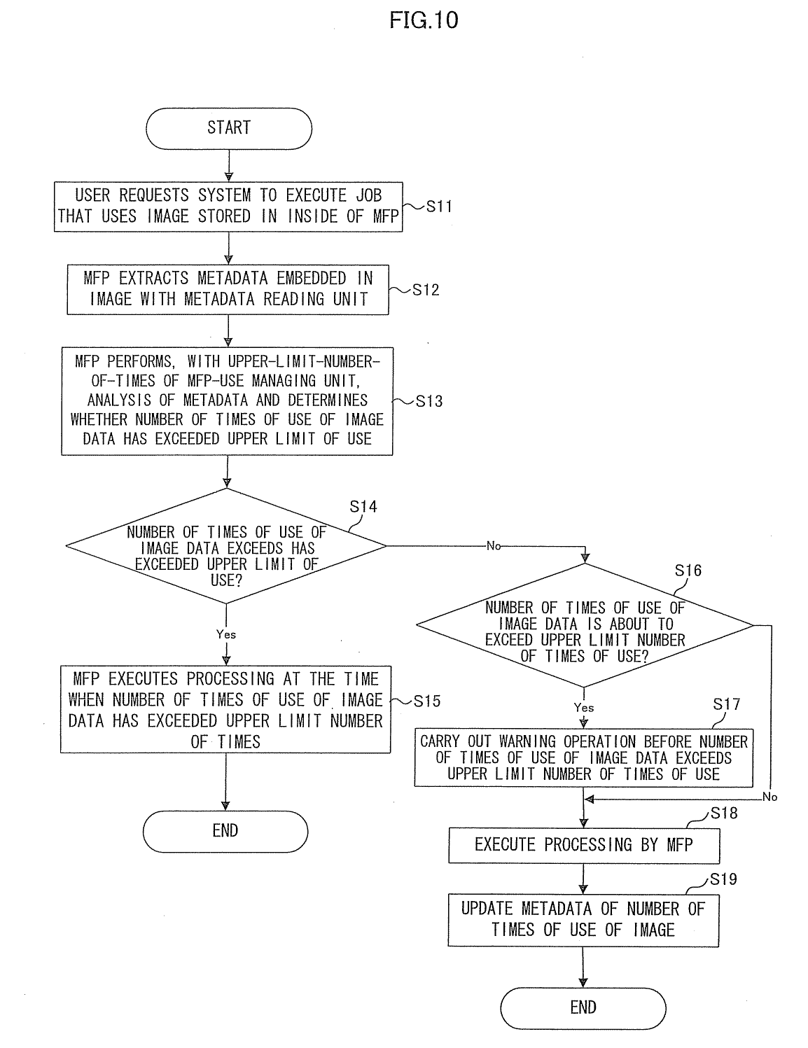

FIG. 10 is a flowchart showing processing of a use restriction operation for an image in the number-of-times-of-image-use restricting apparatus according to this embodiment. In this case, it is assumed that image data inputted in accordance with the flow at the time of metadata registration in FIG. 9 is stored in the inside of the MFP 2 in advance.

First, the user requests a system to execute a job that uses an image stored in the inside of the MFP 2 (step S11). This job is, for example, Box to Print, Box to Email, or Box to Fax.

When the MFP 2 receives a request for execution of a job from the user, the MFP 2 reads out metadata embedded in an image file with the metadata reading unit 24 (step S12). Moreover, the MFP 2 performs, with the upper-limit-number-of-times of MFP-processing-use managing unit 25, analysis of the metadata and determines whether the number of times of use of image data has exceeded an upper limit number of times of use (step S13). If the image data has exceeded the upper limit number of times of use in the determination in step S14 (step S14, Yes), the MFP determines contents set as the “processing at the time when the number of times of use of image data has exceeded an upper limit number of times of use” from the metadata and executes the processing (step S15).

On the other hand, when the image data has not exceeded the upper limit number of times of use in the determination in step S14 (step S14, No), the MFP determines whether the number of times of use of the image data has reached the number of times of use that is about to exceed the upper limit number of times of use (the number of times for issuing a warning) (step S16). When the number of times of use of an image has reached the number of times for issuing a warning (step S16, Yes), the MFP executes a “warning operation before the number of times of use of image data exceeds an upper limit number of times of use” set in the metadata (step S17).

After executing a warning operation for indicating that the number of times of use of the image data has reached the number of times for warning, the MFP executes processing by the MFP requested by the user (e.g., Box to Print, Box to Email, Box to Fax, etc.) (step S18). When the number of times of use of the image has not reached the number of times for issuing a warning in step S16 (step S16, No), the MFP executes the processing by the MFP requested by the user without performing the warning operation (step S18). After executing the processing by the MFP in this way, the MFP adds (updates) the metadata for the image (step S19).

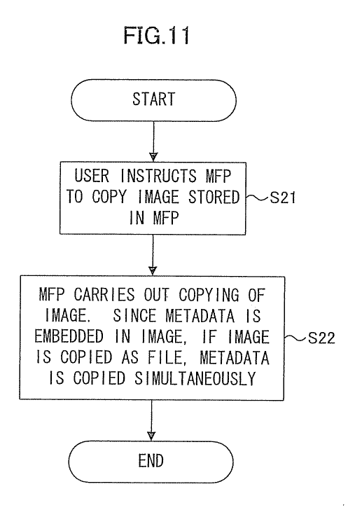

FIG. 11 is a flowchart showing a flow of processing for copying an image file with metadata in the number-of-times-of-image-use restricting apparatus according to this embodiment. First, the user instructs the MFP 2 to copy an image stored in the MFP 2 using the inputting unit 26 of the MFP 2 (step S21). The MFP 2 carries out copying of the image and creates a copy of image file in the inside of the MFP 2. In this case, since metadata is embedded in the image, if the image file is copied, the metadata is copied simultaneously (step S22). In this way, the number-of-times-of-image-use restricting apparatus in this embodiment can inherit metadata information of a copy source when the apparatus copies the image file with metadata.

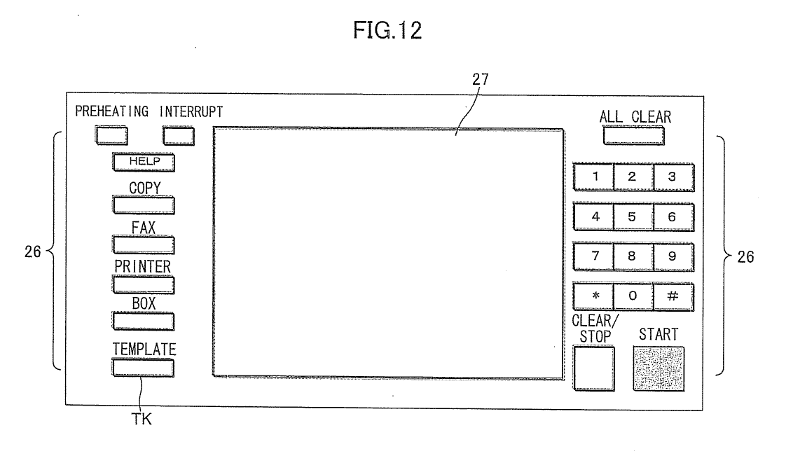

For reference, a control panel of the MFP 2 is shown in FIG. 12. FIG. 12 is a conceptual diagram showing an operation unit of the MFP 2. The control panel of the MFP 2 is a unit equivalent to the inputting unit 26 and the displaying unit 27 shown in FIG. 2. Various hard keys for preheating, interrupt, HELP, copy, facsimile, printer, box, template, all-clear, ten key, clear stop, and start are present on the inputting unit 26. The displaying unit 27 has a touch panel. A template setting screen shown in FIG. 8 is displayed on the displaying unit 27 serving as the touch panel by a template key TK shown on the inputting unit 26. The user can easily set information on restriction on use.

According to the number-of-times-of-image-use restricting apparatus in this embodiment, compared with the case in which all pieces of image use information are managed by the central server as in the patent document 1, it is possible to reduce loads exchanged through a network concerning information on the number of times of use of image data. Since each of MFPs includes a unit that determines restriction on use of the image data, it is possible to immediately execute restriction on use of the image data without overhead. Moreover, even when the image data is moved to another MFP, since it is possible to inherit the number of times of use of the image data, it is possible to continue restriction on the number of time of use. According to the number-of-times-of-image-use restricting apparatus in this embodiment, when the number of times of use of the image data has exceeded the upper limit number of times of use, processing determined in advance is carried out. Thus, a user who needs to learn that the number of times of use of the image data has exceeded the upper limit number of times of use can necessarily learn that the number of times of use of image data has exceeded the upper limit number of times of use. When the number of times of use of image data has exceeded the decided upper limit number of times of use, the user can receive a service with a degraded image quality because the number of times of use of the image data has exceeded the upper limit number of times of use.

It is also possible to apply the metadata storing means, the metadata reading means, the managing means, and the image-formation-processing executing means explained in this embodiment to a program for causing a computer to execute the image forming method explained using the flowcharts described in the embodiment. This program has a function of being recorded in a computer-readable recording medium, read by the computer, and causing the computer to execute the number-of-times-of-image-use restricting method of the invention. Concerning such a function, in the explanation of this embodiment, the function of carrying out the invention is recorded in the apparatus in advance. However, the invention is not limited to this. The same function may be downloaded to the apparatus from a network or the same function stored in a recording medium may be installed in the apparatus. A form of the recording medium may be any form as long as the recording medium is a recording medium that can store a program and is readable by the apparatus such as a CD-ROM. The function obtained by installation and download in this way may be realized in cooperation with an OS (operating system) or the like in the apparatus.

What is claimed is:

1. A number-of-times-of-image-use restricting apparatus comprising:
a metadata storing unit configured to embed, according to use of image data, a number of times of use of the image data in the image data as metadata;
a metadata reading unit configured to read the number of times of use by reading the metadata embedded in the image data; and
a number-of-times-of-use managing unit configured to manage the number of times of use of the image data on the basis of the number of times of use read by the metadata reading unit and a predetermined upper limit number of times of use.

2. A number-of-times-of-image-use restricting apparatus according to claim 1, wherein
the metadata storing unit embeds the upper limit number of times of use in the image data as metadata when the image data is used for the first time,
the metadata reading unit reads the upper limit number of times of use together with the number of times of use, and
the number-of-times-of-use managing unit uses an upper limit number of times of use read by the metadata reading unit as the predetermined upper limit number of times of use.

3. A number-of-times-of-image-use restricting apparatus according to claim 1, wherein the metadata storing unit additionally embeds the number of times of use in the image data in association with a type of image formation processing when the image data is used.

4. A number-of-times-of-image-use restricting apparatus according to claim 1, wherein the number-of-times-of-use managing unit instructs an image-formation-processing executing unit, which executes image formation processing, about possibility of execution of the image formation processing.

5. A number-of-times-of-image-use restricting apparatus according to claim 1, wherein the number-of-times-of-use managing unit notifies, when the number of times of use of the image data has reached a predetermined number of times of use smaller than the upper limit number of times of use, an owner of the image data to that effect.

6. A number-of-times-of-image-use restricting apparatus according to claim 1, wherein the number-of-times-of-use managing unit executes, when the number of times of use of the image data has exceeded the upper limit number of times of use, processing set in advance.

7. A number-of-times-of-image-use restricting apparatus according to claim 6, wherein the processing set in advance is processing for notifying, by electronic mail, a predetermined destination that the number of times of use of the image data has exceeded a predetermined number of times.

8. A number-of-times-of-image-use restricting apparatus according to claim 6, wherein the processing set in advance is processing for instructing an image-formation-processing executing unit to perform image formation processing with a degraded image quality.

9. A number-of-times-of-image-use restricting apparatus according to claim 5, wherein the processing set in advance is processing for instructing an image-formation-processing executing unit to perform image formation processing subjected to overlay.

10. A number-of-times-of-image-use restricting apparatus according to claim 8, wherein the image formation processing is processing for printing an image or forming a file of the image.

11. A number-of-times-of-image-use restricting apparatus according to claim 1, wherein, when the image data embedded with the metadata is copied, the metadata is embedded in the image data copied such that information of the metadata is inherited.

12. A number-of-times-of-image-use restricting apparatus according to claim 3, wherein
the predetermined upper limit number of times of use is decided in association with a type of the image formation processing, and
the number-of-times-of-use managing unit manages the number of times of use for each type of the image formation processing.

13. A number-of-times-of-image-use restricting apparatus according to claim 1, comprising a template for setting the upper limit number of times of use.

14. A number-of-times-of-image-use restricting apparatus comprising:
metadata storing means for embedding, according to use of image data, a number of times of use of the image data in the image data as metadata;
metadata reading means for reading the number of times of use by reading the metadata embedded in the image data; and
number-of-times-of-use managing means for managing the number of times of use of the image data on the basis of the number of times of use read by the metadata reading unit and a predetermined upper limit number of times of use.

15. A number-of-times-of-image-use restricting apparatus according to claim 14, wherein
the metadata storing means embeds the upper limit number of times of use in the image data as metadata when the image data is used for the first time,
the metadata reading means reads the upper limit number of times of use together with the number of times of use, and
the number-of-times-of-use managing means uses an upper limit number of times of use read by the metadata reading means as the predetermined upper limit number of times of use.

16. A number-of-times-of-image-use restricting apparatus according to claim 14, wherein the metadata storing means additionally embeds the number of times of use in the image data in association with a type of image formation processing when the image data is used.

17. A number-of-times-of-image-use restricting apparatus according to claim 14, wherein, when the image data embedded with the metadata is copied, the metadata is embedded in the image data copied such that information of the metadata is inherited.

18. A number-of-times-of-image-use restricting apparatus according to claim 3, wherein
the predetermined upper limit number of times of use is decided in association with a type of the image formation processing, and
the number-of-times-of-use managing unit manages the number of times of use for each type of the image formation processing.

19. A number-of-times-of-image-use restricting apparatus according to claim 16, comprising a template for setting the upper limit number of times of use.

20. A number-of-times-of-image-use restricting method comprising:
embedding, according to use of the image data, the number of times of use of the image data as metadata;
reading the metadata embedded to acquire the number of times of use when the image data is used the next time; and comparing the number of times acquired with a predetermined upper limit number of times of use to manage the number of times of use of the image data.
